(19) United States
(12) Patent Application Publication
(10) Pub. No.: US 2010/0152923 A1
(43) Pub. Date: Jun. 17, 2010

(54) DYNAMIC DISPLAY OF NAVIGATIONAL INFORMATION

(76) Inventors: Sven D. Aspen, Sherwood, OR (US); Andreas Sindlinger, Weinheim (DE); Patrick Wipplinger, Moerfelden-Walldorf (DE)

Correspondence Address: HARNESS DICKEY & PIERCE, PLC, P.O. BOX 828, BLOOMFIELD HILLS, MI, 48303, US

(21) Appl. No.: 12/333,885

(22) Filed: Dec. 12, 2008

(51) Int. Cl. G06F 19/00; G01C 21/00

(52) U.S. Cl. 701/3; 701/200

(57) ABSTRACT

A display system for dynamically displaying aircraft flight information. The system includes a processor, memory, and a display. The processor is capable of communicating with the memory, the display, and a system environment of the aircraft. The processor is configured to display a flight map for the aircraft on the display, to evaluate state variable(s) dynamically representing state(s) in the aircraft system environment, and dynamically modify the flight map based at least in part on the evaluation.

### FIELD

The present disclosure relates generally to navigational displays and more particularly (but not exclusively) to dynamically displaying navigational data for a craft such as an aircraft or water vessel.

### BACKGROUND

This section provides background information related to the present disclosure which is not necessarily prior art.

Aircraft pilots generally refer to aeronautical maps for flight path information. Flight maps, which may be digitally displayed, typically show departure and arrival locations, terrain, and landmarks on or near the flight path. An aircraft following a flight path may encounter various changes in terrain, weather, etc. and the pilot may need to react accordingly. A pilot may alter aircraft speed, altitude and/or other flight parameters in response to changing conditions along the flight path. Not all pilots follow the same procedures during flight. Airline-specific practices may vary in their requirements for pilots to follow at specific times relative to predefined events.

### SUMMARY

This section provides a general summary of the disclosure, and is not a comprehensive disclosure of its full scope or all of its features.

In one implementation, the present disclosure is directed to a dynamic display system for dynamically displaying navigational information. The system includes a processor, memory, and a display. The processor is capable of communicating with the memory, with the display, and with a system environment of a craft as to which the navigational information is displayed. The processor is configured to display a navigational map for the craft on the display. The processor is further configured to evaluate one or more state variables dynamically representing one or more states in the craft system environment, and dynamically modify the navigational map based at least in part on the evaluation.

In another implementation, the disclosure is directed to a dynamic display system for dynamically displaying aircraft flight information. The system includes a processor, memory, and a display. The processor is capable of communicating with the memory, with the display, and with a system environment of an aircraft. The system environment includes a plurality of states relating to systems of the aircraft. The processor is configured to display a flight map for the aircraft on the display, evaluate one or more state variables dynamically representing one or more of the states, and dynamically modify the displayed flight map based at least in part on the evaluation and one or more rules provided by a user of the dynamic display system relating to the state variable(s).

In yet another implementation, the disclosure is directed to a method of displaying aircraft flight information. The method is performed by a dynamic display system including a processor in communication with memory and with a display. A flight map is displayed for the aircraft. The method includes obtaining one or more rules specified by a user of the dynamic display system, and accessing one or more state variables dynamically representing one or more states in a system environment of the aircraft. The accessing is performed at least in part by executing instructions provided by the user of the dynamic display system. The method further includes evaluating the state variable(s) relative to the rule(s), and based on the evaluating, modifying the displayed flight map.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a conceptual diagram of a system for dynamically displaying navigational information in accordance with one implementation of the disclosure;

FIG. 2 is a logical architectural view of a framework for a dynamic display system in accordance with one implementation of the disclosure;

FIG. 3 is a screen shot of a logic tree in accordance with one implementation of the disclosure;

and

FIG. 4 is a flow diagram of a method of displaying navigational information in accordance with one implementation of the disclosure.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

In various implementations of the disclosure, a system is provided for dynamically displaying navigational information for a craft such as an aircraft, a spacecraft, a ship or other watercraft. The system, which is data-driven and rule-based, can provide for the display of information in a context-aware manner. Information that a navigator needs can be displayed to the navigator when he/she needs the information. Information not needed at a given time can be selectively filtered from the display. In various implementations, the system allows users, e.g., aircraft or ship providers, airlines, shipping lines, ship captains and/or pilots, to implement their own preferences and/or requirements for when and how data may be displayed by the system.

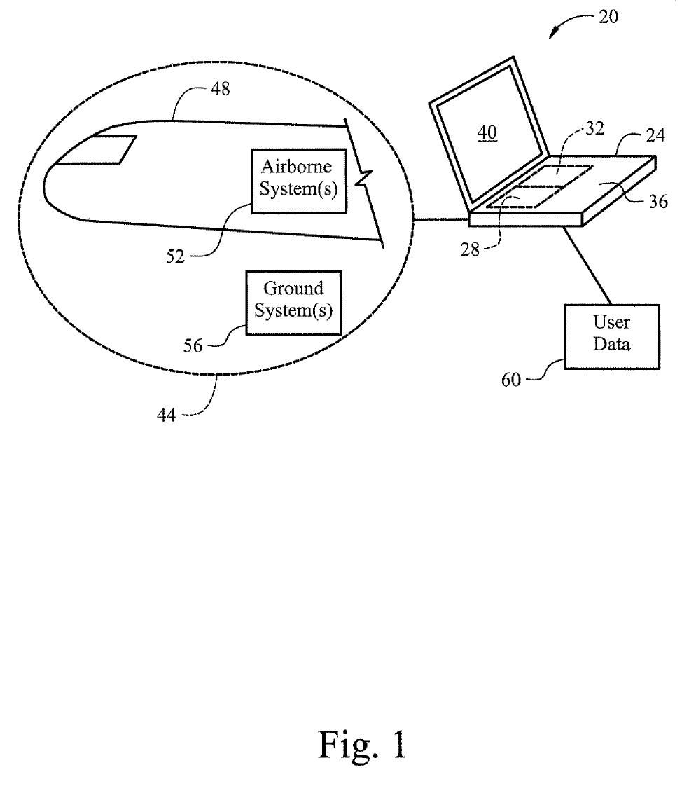

One configuration of a system for dynamically displaying navigational information is indicated generally in FIG. 1 by reference number 20. The system 20 is for displaying aircraft flight information and includes a computer, e.g., a laptop electronic flight bag (EFB) 24. The EFB 24 has a processor 28, memory 32, a keyboard 36 and/or other user input means, and a display 40. The EFB 24 is portable and may be used onboard or away from aircraft. It should be noted that other or additional computer configurations, including, e.g., an onboard navigational and/or other computing system of an aircraft, could be used to provide a dynamic display as further described below.

The EFB 24 is capable of communicating with a system environment 44 of an aircraft 48. The environment 44 includes various states in and/or relating to various airborne systems 52 and ground systems 56. The EFB processor 28 is configured to display a flight map on the display 40. When, for example, the aircraft 48 is in flight, the processor 28 evaluates one or more state variables dynamically representing one or more states in the aircraft system environment 44. State variables may represent a wide variety of states including, e.g., aircraft altitude, current aircraft location, direction, air speed, ground speed, pitch and other flight parameters, distance to a topographical feature, height of a topographical feature, aircraft fuel level, weather condition(s), time of day, traffic frequency, characteristics of airports, etc. The processor 28 dynamically modifies the displayed flight map based at least in part on one or more rules relating to the evaluated state variable(s). Such rules may specify, among other things, how and/or when a particular symbol is to be displayed on the flight map. For example, a state variable “DistToObject” may be dynamically evaluated as a distance from a current position of the aircraft to another object, e.g., an airport. A rule may specify that unless the distance represented by the variable “DistToObject” is below a predefined amount, a symbol for that object is not to be displayed on the flight map.

The dynamic display system 20 may refer to a plurality of rules and state variables in determining whether and how to display objects on a flight map. Additionally or alternatively, the display system 20 may include and refer to one or more data sources 60 provided by one or more users of the display system 20. Such user(s) may include a manufacturer of the aircraft 48, an airline or other provider of the aircraft 48, and/or a pilot of the aircraft 48. The data source(s) 60 may include one or more user definitions of state variables and/or one or more user-defined rules relating to state variable(s). The processor 28 may execute instructions provided in the data source(s) 60 to obtain one or more user-defined rules. The processor 28 may also execute instructions provided in the data source(s) 60 to evaluate a state variable periodically and/or occasionally, dependent on rule(s) to which the state variable pertains.

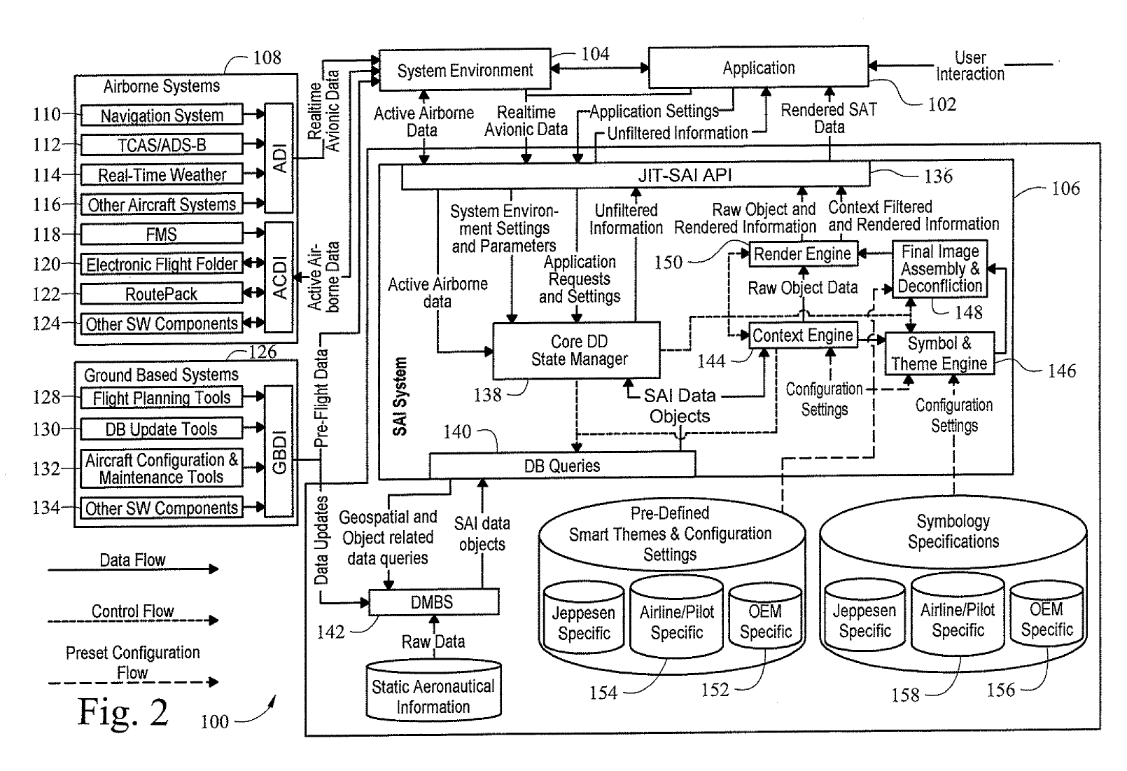

A logical architectural view of a framework for a dynamic display system is indicated generally in FIG. 2 by reference number 100. A pilot or other user activates a display application 102, e.g., on an EFB. The application 102 is in communication with an aircraft system environment 104 and with a dynamic display system 106. The system 106 is occasionally referred to as a supplemental aircraft information (SAI) system. The system environment 104 includes real-time avionic data from various airborne systems 108, including a navigation system 110, a traffic alert collision avoidance/automatic dependent surveillance-broadcast (TCAS/ADS-B) system 112, real-time weather data 114, and other aircraft systems 116. The environment 104 also includes active airborne data from a flight management system (FMS) 118, an electronic flight folder 120, a route pack 122, and other software components 124. The environment 104 also includes pre-flight data, which may be updated, e.g., before and/or during flight from various ground-based systems 126 such as flight planning tools 128, database update tools 130, aircraft configuration and maintenance tools 132, and other software components 134.

Information from the system environment 104 and user application 102 is available to the display system 106 via an application program interface (API) 136. Active airborne data, system environment settings and parameters, and application requests and settings are made available via the API 136 to a data-driven state manager 138 that manages the dynamic rendering of a flight map. Although not shown in FIG. 2, user-provided software for defining and handling user-provided dynamic state variables may also be made available to the state manager 138 via the API 136.

The state manager 138 may perform queries 140 against a database management system (DBMS) 142 to obtain additional aeronautical information for use in controlling the display of flight map information. The state manager 138 controls a context engine 144, a symbol and theme engine 146, a final image assembly and deconfliction engine 148, and a render engine 150 to provide raw object and rendered information and context-filtered and rendered information to the user application 102 via the API 136.

Manufacturer configuration settings 152 and/or airline/pilot configuration settings 154 may be predefined and made available to the dynamic display system 106. Manufacturer symbology specifications 156 and/or airline/pilot symbology specifications 158 also may be predefined and made available to the dynamic display system 106. In such manner, a user can provide custom rules relating to dynamic state variables, including but not limited to dynamic state variables defined by a user as described above.

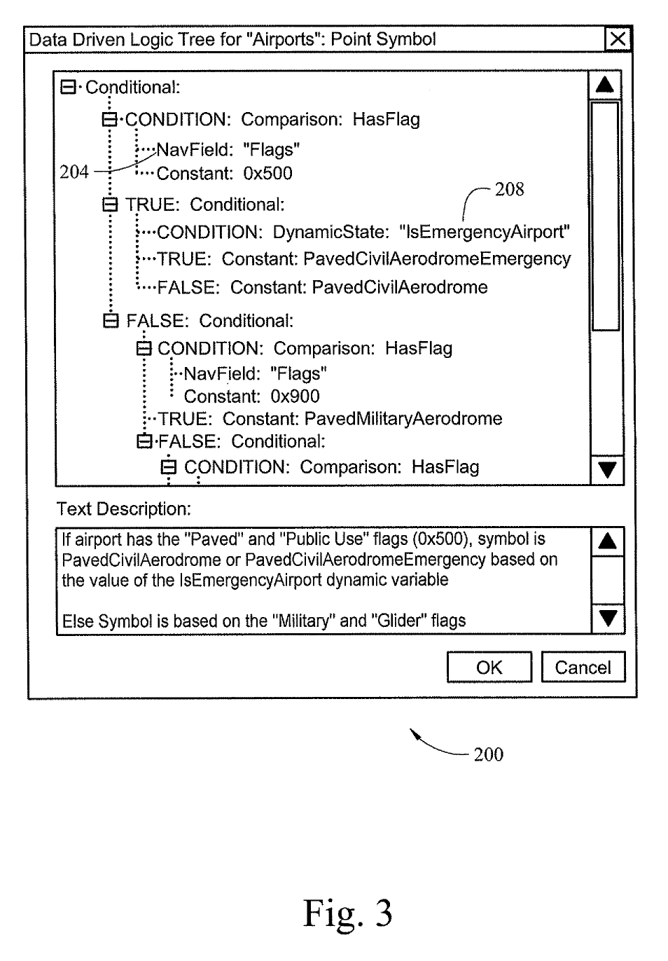

In various dynamic display system configurations, logic trees are used to specify rules for displaying data on a flight display. Such logic trees are driven by data, including dynamic state variables, to provide context-aware display of information. In various implementations an editor program is provided whereby a user may construct and/or edit a logic tree, for example, as indicated generally in FIG. 3 by reference number 200. In one implementation the editor program is written in C++ programming language, although other programming languages could be used. The exemplary logic tree 200 defines how and when a symbol for an airport and a label for the symbol are displayed. When a processor executes the logic tree 200, it accesses data fields such as “NavField” 204 from a raw airport data record. The processor also evaluates dynamic state variables such as “IsEmergencyAirport” 208. The logic tree 200 specifies that if a subject airport is flagged as being paved and public-use, then (based on a dynamic variable indicating whether the airport is an emergency airport,) a symbol for a paved civil aerodrome or for a paved civil emergency aerodrome is to be displayed. Otherwise, a symbol type for the airport is to be determined in accordance with whether the airport is flagged as “military” or “glider”. Other or additional parameters for rendering a symbol for the airport, e.g., parameters for size and/or color, may be defined in other or additional similarly structured logic trees.

In various implementations, a dynamic display system user, e.g., an aircraft manufacturer, may define dynamic parameters as state variables that can be incorporated into logic trees. Evaluation of such parameters may be accomplished, e.g., via a callback by the dynamic display system to software code provided by the user to evaluate a current value of the dynamic variable representing the dynamic parameter.

Logic trees and dynamic state variables may be used to define many different data-driven attributes of a dynamic display system in accordance with various implementations. For example, chart object filtering and display attributes may be defined, e.g., to specify when and/or how certain chart objects are displayed on a flight map. Configuration settings for the flight map may be dynamically changed based at least in part on the rules. Complex layout and depiction of labels, e.g., components and layout of a VOR (VHF Omnidirectional Range) label, may be performed dynamically. Different types of labels may be defined, for example, to indicate traffic frequency and/or radio frequency, and specified for display based, e.g., on proximity of an aircraft to an arrival destination. Chart layers and chart layer stacking order may be performed dynamically, e.g., to define an order in which chart layers are displayed. Thus, for example, a chart layer indicating a weather condition may be placed in a chart stack based at least in part on the particular weather condition. Various alerts and notifications may be displayed when considered appropriate by a display system user. For example, when an aircraft approaches a particular airport that the pilot is expected to call upon arrival, a message such as “Approaching Frankfurt Class C” could be displayed along with an appropriate radio frequency in accordance with the provided rules (e.g., logic tree and state variables) and current dynamic state. In some implementations an auto-zooming capability may be provided, e.g., based on one or more rules for different stages within a mission.

One example of a flight map that is changed in accordance with one implementation of the disclosure shall now be described. The map is displayed in an aircraft that is indicated by an aircraft shape on the map. Contents of the map may be changed in accordance with a rule pertaining at least in part to aircraft velocity, which is a dynamic state of the aircraft. The map is displayed in one form when the aircraft is in a touch-down phase and when the velocity, shown in an area of the map, is greater than or equal to 40 knots. The map displays, e.g., elevation and altitude information.

The map is displayed differently when the aircraft is taxiing and traveling at velocity less than 40 knots. Elevation and altitude information are not shown, but details are displayed that are not displayed in the map as previously shown. For example, runway information, airport buildings, and ground facilities information are shown.

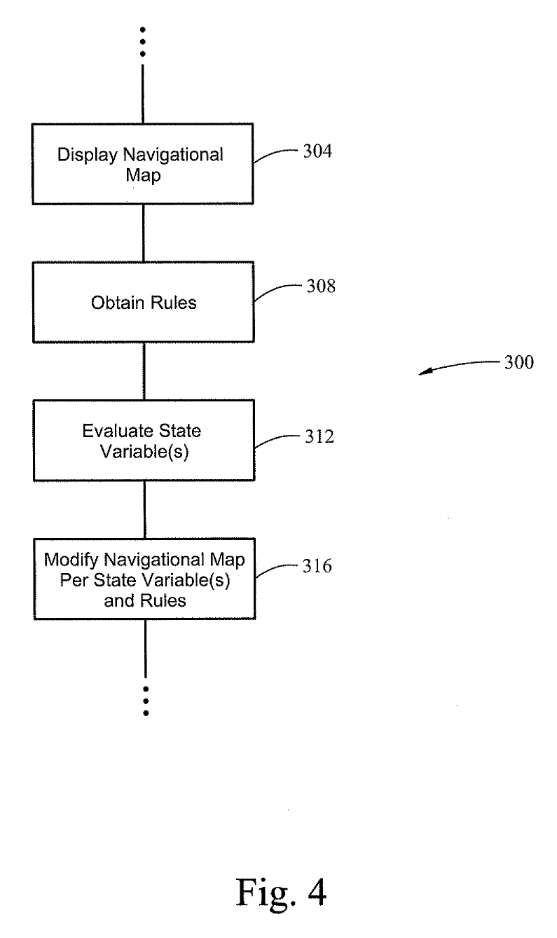

It will be appreciated by those skilled in the art that navigational and display systems used, e.g., in watercraft are different in various respects from those used in aircraft. It will also be appreciated, however, that the disclosure could be implemented, e.g., in relation to watercraft without departing from the principles of the present disclosure. One implementation of a method for displaying navigational information is indicated generally in FIG. 4 by reference number 300. The method 300 may be performed by a dynamic display system including a processor in communication with memory and with a display. It should be understood that the various processes of the method 300 do not necessarily have to be performed in the order set forth in FIG. 4. Furthermore, other or additional processes may be performed in connection with the processes shown in FIG. 4.

In process 308, one or more rules, e.g., specified by a user of the dynamic display system, are obtained. In process 304, a navigational map for a craft is displayed. In process 312, one or more state variables dynamically representing one or more states in a system environment of the craft are accessed and evaluated. The accessing may be performed at least in part, e.g., by executing instructions provided by the user of the dynamic display system. The state variables are evaluated relative to the one or more rules. If it is determined that the navigational map is to be changed based on the evaluation, then in process 316 the display of the navigational map is modified. Control then may return to process 312.

The data-driven aspects of the foregoing display systems and methods make it possible for individual users to define a unique “look-and-feel” for their chart display. Custom rules can be defined for displaying context-sensitive information with having to perform changes to source code. This feature is in contrast to current display systems, which typically use hard-coded rules to define content and appearance, thus requiring software updates to change rules. The foregoing systems and methods are in contrast to current systems that typically perform filtering based only on scale (i.e., certain objects may be turned off when the display is zoomed out beyond a certain point.) Systems and methods in accordance with the disclosure can be used, e.g., during aircraft flight to enhance situational awareness during flight and can reduce workload for pilots. Such systems can entail fewer software updates and less maintenance than existing systems.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A dynamic display system for dynamically displaying navigational information, the system comprising a processor, memory, and a display;
the processor capable of communicating with the memory, with the display, and with a system environment of a craft as to which the navigational information is displayed, the processor configured to:
display a navigational map for the craft on the display;
evaluate one or more state variables dynamically representing one or more states in the craft system environment; and
dynamically modify the navigational map based at least in part on the evaluation.

2. The dynamic display system of claim 1, the processor further configured to dynamically modify the navigational map based at least in part on one or more rules relating to the one or more state variables.

3. The dynamic display system of claim 2, the processor configured to execute instructions provided by a user of the dynamic display system to obtain at least one of the one or more rules.

4. The dynamic display system of claim 1, the processor configured to execute instructions provided by a user of the dynamic display system to dynamically evaluate at least one of the one or more state variables.

5. The dynamic display system of claim 1, comprising an electronic flight bag (EFB) that includes the processor, memory, and display.

6. The dynamic display system of claim 1, the processor configured to execute instructions provided by a user of the dynamic display system to obtain information from the craft system environment.

7. The dynamic display system of claim 6, the craft system environment including data from airborne systems and ground-based systems.

8. The dynamic display system of claim 1, the craft including one of the following: an aircraft, a spacecraft, and a watercraft.

9. A dynamic display system for dynamically displaying aircraft flight information, the system comprising a processor, memory, and a display;
the processor capable of communicating with the memory, with the display, and with a system environment of an aircraft, the system environment including a plurality of states relating to systems of the aircraft, the processor configured to:
display a flight map for the aircraft on the display;
evaluate one or more state variables dynamically representing one or more of the states; and
dynamically modify the displayed flight map based at least in part on the evaluation and one or more rules provided by a user of the dynamic display system relating to the one or more state variables.

10. The dynamic display system of claim 9, the processor configured to execute instructions provided by a user of the dynamic display system to obtain at least one of the one or more rules.

11. The dynamic display system of claim 9, the processor configured to execute instructions provided by a user of the dynamic display system to evaluate at least one of the one or more state variables.

12. The dynamic display system of claim 9, the processor configured to execute instructions provided by a user of the dynamic display system to obtain data from the system environment to evaluate at least one of the one or more state variables.

13. The dynamic display system of claim 9, configured at least partly in an electronic flight bag (EFB).

14. A method of displaying aircraft flight information, the method performed by a dynamic display system including a processor in communication with memory and with a display, the method comprising:
displaying a flight map for the aircraft;
obtaining one or more rules specified by a user of the dynamic display system;
accessing one or more state variables dynamically representing one or more states in a system environment of the aircraft, the accessing performed at least in part by executing instructions provided by the user of the dynamic display system;
evaluating the one or more state variables relative to the one or more rules; and
based on the evaluating, modifying the displayed flight map.

15. The method of claim 14, further comprising dynamically changing a configuration setting for the displayed flight map based at least in part on the one or more rules.

16. The method of claim 14, further comprising dynamically selecting a symbol for the flight map based at least in part on the one or more rules.

17. The method of claim 14, further comprising stacking chart layers in accordance with the one or more rules.

18. The method of claim 14, further comprising displaying an alert in accordance with the one or more rules.

19. The method of claim 14, further comprising zooming the flight map in or out in accordance with the one or more rules.

20. The method of claim 14, performed at least in part by an electronic flight bag (EFB).
